(19) United States
(12) Patent Application Publication
(10) Pub. No.: US 2025/0202403 A1
(43) Pub. Date: Jun. 19, 2025

(54) DETECTION OF PULSE-WIDTH MODULATION DUTY CYCLE ERRORS

(71) Applicant: Rivian IP Holdings, LLC, Irvine, CA (US)

(72) Inventors: Thomas Fredrick MILLER, Santa Barbara, CA (US); Fareed UI Hasan SYED MOHAMMED, Hawthorne, CA (US); Reynaldo Arturo SUAZO ZEPEDA, Torrance, CA (US); Younes SANGSEFIDI, Irvine, CA (US); Chia-Chou YEH, Torrance, CA (US)

(21) Appl. No.: 18/389,629

(22) Filed: Dec. 19, 2023

(51) Int. Cl. H02P 27/08; H02H 7/08; H02H 7/093; H02K 11/21; H02K 11/27

(52) U.S. Cl. CPC H02P 27/085; H02H 7/0822; H02H 7/0844; H02H 7/093; H02K 11/21; H02K 11/27

(57) ABSTRACT

Techniques for detecting pulse-width modulation (PWM) duty cycle errors are disclosed. The techniques include receiving a PWM signal for output to a gate drive of a motor controller and detecting a first duty cycle error associated with the PWM signal based on a comparison of the PWM signal with a corresponding PWM command. The techniques further include triggering, in response to detecting the first duty cycle error, a safe state at the gate drive of the motor controller.

### INTRODUCTION

Pulse-width modulation (PWM) is commonly implemented to control the operation of various vehicle systems, for example, by modifying a duty cycle of a PWM signal. Increasing the duty cycle of a PWM signal increases the amount of time that the signal is in the ‘on’ state (e.g., causing more power to be supplied to a particular component), while decreasing the duty cycle of a PWM signal decreases the amount of time that the signal is in the ‘on’ state (e.g., causing less power to be supplied to a particular component). Because PWM is increasingly utilized to control the operation of components in a number of use cases (e.g., electric vehicles), improved techniques for implementing PWM signals are needed.

### SUMMARY OF THE INVENTION

The present disclosure relates to vehicles, and more specifically, to detection of pulse-width modulation (PWM) duty cycle errors.

In one or more embodiments, a system for detecting PWM duty cycle errors is disclosed. The system includes a memory and at least one processor coupled to the memory. The at least one processor is configured to receive a PWM signal for output to a gate drive of a motor controller, detect a first duty cycle error associated with the PWM signal by comparing the PWM signal with a corresponding PWM command, and in response to detecting the first duty cycle error, trigger a safe state at the gate drive of the motor controller.

In one or more embodiments, a method for detecting PWM duty cycle errors is disclosed. The method is implemented by one or more computer systems and includes receiving a pulse-width modulation PWM signal for output to a gate drive of a motor controller, detecting a duty cycle error associated with the PWM signal based on a comparison of the PWM signal with a corresponding PWM command, and triggering, in response to detecting the duty cycle error, a safe state at the gate drive of the motor controller.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting in scope, and may admit to other equally effective embodiments.

FIG. 1 illustrates an example vehicle, in accordance with embodiments of the present disclosure.

FIG. 2 illustrates an example system for detecting pulse-width modulation (PWM) duty cycle errors, in accordance with embodiments of the present disclosure.

FIG. 3 is a flowchart illustrating a method of triggering a safe state at a gate drive of a motor controller in response to detecting a duty cycle error associated with a PWM signal, in accordance with embodiments of the present disclosure.

FIG. 4 is a flowchart illustrating a method of detecting duty cycle errors, in accordance with embodiments of the present disclosure.

FIG. 5A is a schematic of an example computer system, in accordance with embodiments of the present disclosure.

FIG. 5B illustrates example firmware for a vehicle electronic control unit (ECU), in accordance with embodiments of the present disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Pulse-width modulation (PWM) is commonly used to control (increase or decrease) an amount of power supplied to components of vehicle systems. The amount of power supplied to a particular component is controlled by modifying a duty cycle of a PWM signal. Increasing the duty cycle causes more power to be supplied to the particular component, while decreasing the duty cycle causes less power to be supplied to the particular component. In general, a duty cycle error occurs when a PWM signal is generated based on a PWM command, and a duty cycle of the PWM signal differs from a duty cycle of the PWM command, for example, by more than a threshold amount. Because PWM is used to supply power to components of a vehicle, a duty cycle error may cause more or less power than intended to be supplied to a particular vehicle component, which may unintentionally impact the vehicle component. Certain embodiments described herein provide more accurate systems for detecting duty cycle errors and triggering a safe state in response to detecting a duty cycle error.

In particular, embodiments herein describe systems and techniques for detecting duty cycle errors both directly and indirectly to improve detection accuracy. In order to detect a duty cycle error directly, in various embodiments, a duty cycle of a PWM signal can be compared with a duty cycle of a PWM command that was processed to generate the PWM signal. If the duty cycle of the PWM signal differs from the duty cycle of the PWM command by more than a threshold amount, then a duty cycle error is detected, and a safe state is triggered. In general, triggering the safe state prevents an occurrence of one or more additional duty cycle errors.

In order to detect a duty cycle error indirectly, in various embodiments, a characteristic of a vehicle component controlled by a PWM signal may be monitored. In an example in which the vehicle component is a rotational component of a motor, a torque of the vehicle component can be monitored, for example, by comparing a result of a voltage-based torque calculation with a result of a current-based torque calculation. If these results differ by more than a threshold amount, then a torque monitor failure may be identified, and a calculated phase current for safe action of the torque monitor failure may be compared with a measured phase current for the safe action of the torque monitor failure. In some embodiments, if the calculated phase current differs from the measured phase current by more than a threshold amount, then a duty cycle error is detected, and a safe state is triggered. In this rotational component example, triggering the safe state could include triggering an open switch state or a closed switch state of a motor controller of the motor.

Among other advantages, the techniques described herein provide more accurate systems for detecting duty cycle errors both directly and indirectly as well as triggering a safe state in response to detecting a duty cycle error.

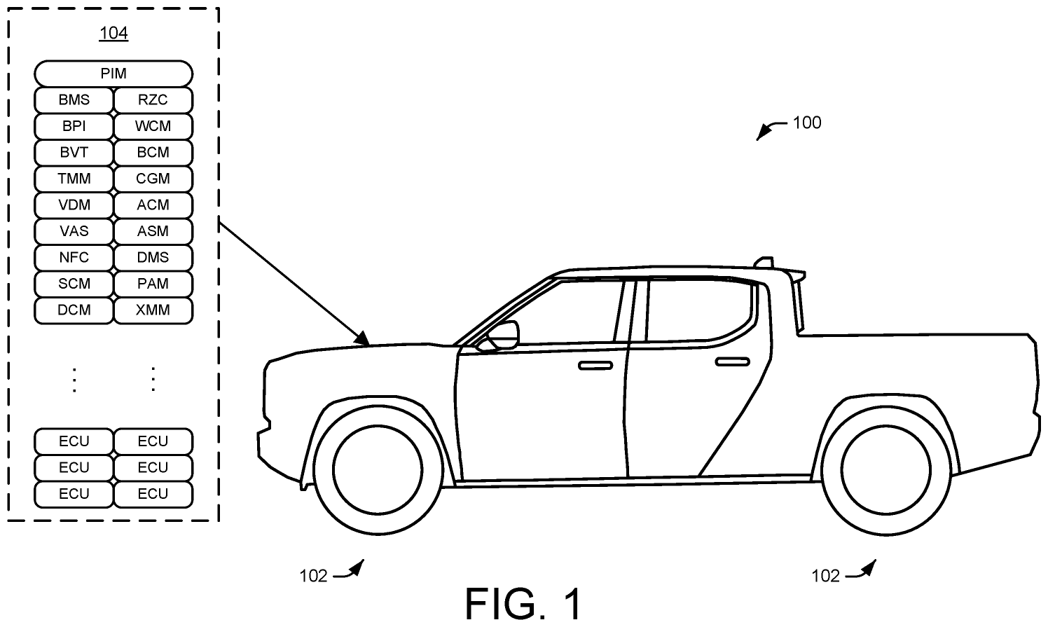

FIG. 1 illustrates an example vehicle 100, in accordance with embodiments of the present disclosure. Vehicle 100 is illustrated to include wheels 102 and a control system 104. For instance, vehicle 100 may include various controllable components (e.g., doors, seats, windows, lights, heating, ventilation and air conditioning (HVAC), an entertainment system, a security system, charging reservation systems, etc.), instrument and information displays and/or interactive interfaces, and so forth. In some embodiments, control system 104 enables control of various systems and subsystems which are included on-board vehicle 100 (e.g., on or within vehicle 100) and/or that are communicatively coupled to vehicle 100 (e.g., via wireless connections).

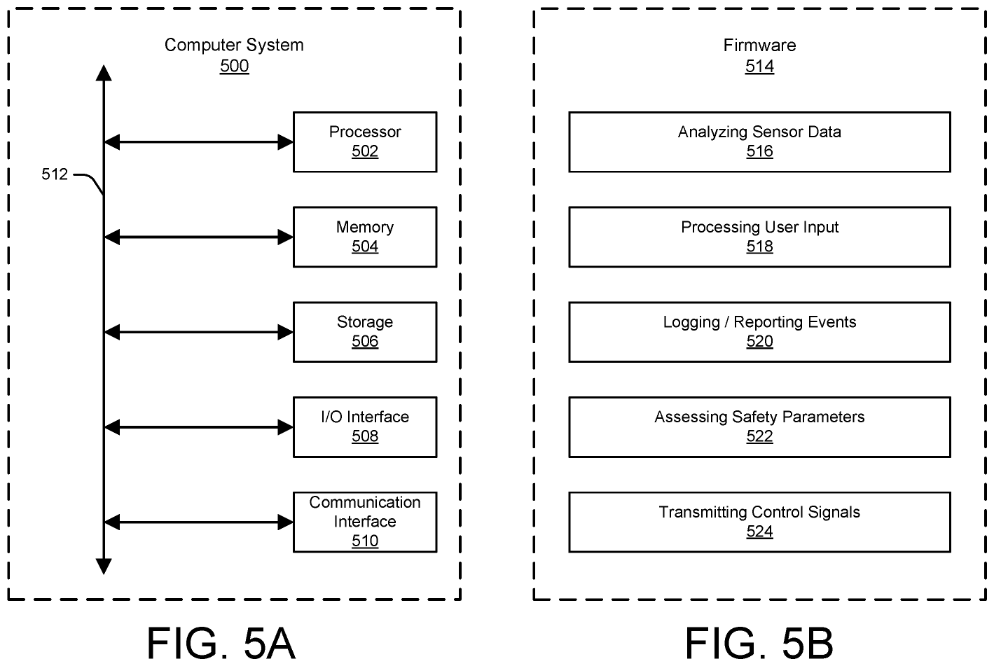

As shown in FIG. 1, control system 104 may comprise one or more electronic control units (ECUs), each of which is dedicated to a specific set of functions (e.g., or multiple specific sets of functions). Each ECU can include (or is implementable as) a computer system (as described further with respect to FIGS. 5A and 5B), and each ECU may include functionality provided by one or more of the example ECUs described below.

Features of embodiments as described herein may be controlled by a Power Inverter Module (PIM) ECU. In one or more embodiments, the PIM ECU monitors pulse-width modulation (PWM) signals that control various components of vehicle 100. In various embodiments, the PIM ECU may detect a duty cycle error by determining that the duty cycle of a PWM signal differs by more than a threshold amount from a duty cycle of a PWM command that was processed to generate the PWM signal. The PIM ECU can determine this difference by directly comparing the duty cycle of the PWM signal with the duty cycle of the PWM command.

In some embodiments, the PIM ECU may also detect a duty cycle error using other techniques which indicate that a duty cycle of a PWM signal differs from an intended duty cycle.

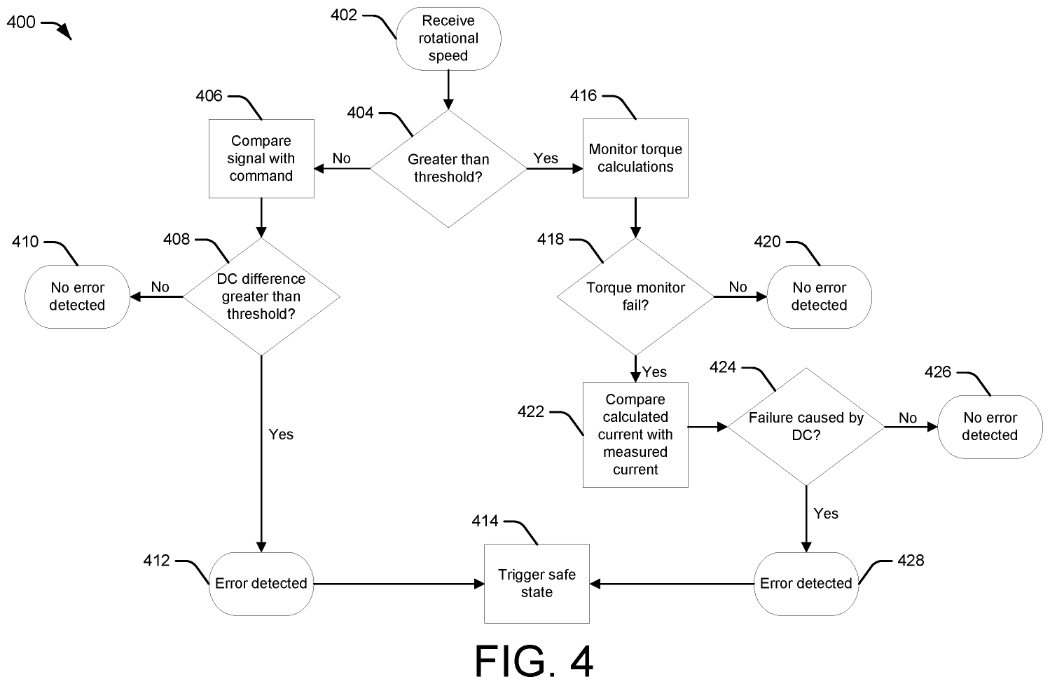

In various embodiments, the PIM ECU detects a duty cycle error by monitoring characteristics of a component that is controlled using PWM signals, such as a rotational component of vehicle 100 (e.g., a motor component). In embodiments in which PWM signals control an amount of torque applied to the rotational component of vehicle 100, the PIM ECU may detect a duty cycle error by first comparing the results of different torque calculations (e.g., comparing a result of a voltage-based torque calculation with a result of a current-based torque calculation). If the results of the different torque calculations differ by more than a threshold amount, then the PIM ECU can further compare a calculated phase current for safe action of torque monitor failure (e.g., an expected phase current) for the rotational component with a measured phase current for the safe action of the torque monitor failure of the rotational component to determine whether a duty cycle error has occurred. In various embodiments, if the PIM ECU detects a duty cycle error, then the PIM ECU may determine a response to the duty cycle error, such as by triggering a safe state (described below in further detail in conjunction with FIG. 4).

The control system 104 may also include a Central Gateway Module (CGM) ECU. The CGM ECU may serve as a communications hub of vehicle 100 that connects and transfers data to and from the various ECUs (e.g., the PIM ECU), sensors, cameras, motors, and other components of vehicle 100. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing vehicle 100 in one of the vehicle modes. In some embodiments, for electric vehicles, the CGM ECU may also control the vehicle charge port door and related light(s) and sensor(s). In various embodiments, the CGM ECU collects sensor signals from one or more sensors of vehicle 100. For example, the CGM ECU may record any hard stopping events, the following distance of vehicle 100 behind other vehicles, measurements of torque on a component of vehicle 100 based on hard-cornering events, and/or the like.

Vehicle 100 may include one or more additional ECUs, such as, by way of example and not limitation: a Vehicle Dynamics Module (VDM) ECU, an Experience Management Module (XMM) ECU, a Vehicle Access System (VAS) ECU, a Panel Access Module (PAM) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of vehicle 100, such as a Battery Management System (BMS) ECU, a Battery Power Isolation (BPI) ECU, a Balancing Voltage Temperature (BVT) ECU, and/or a Thermal Management Module (TMM) ECU.

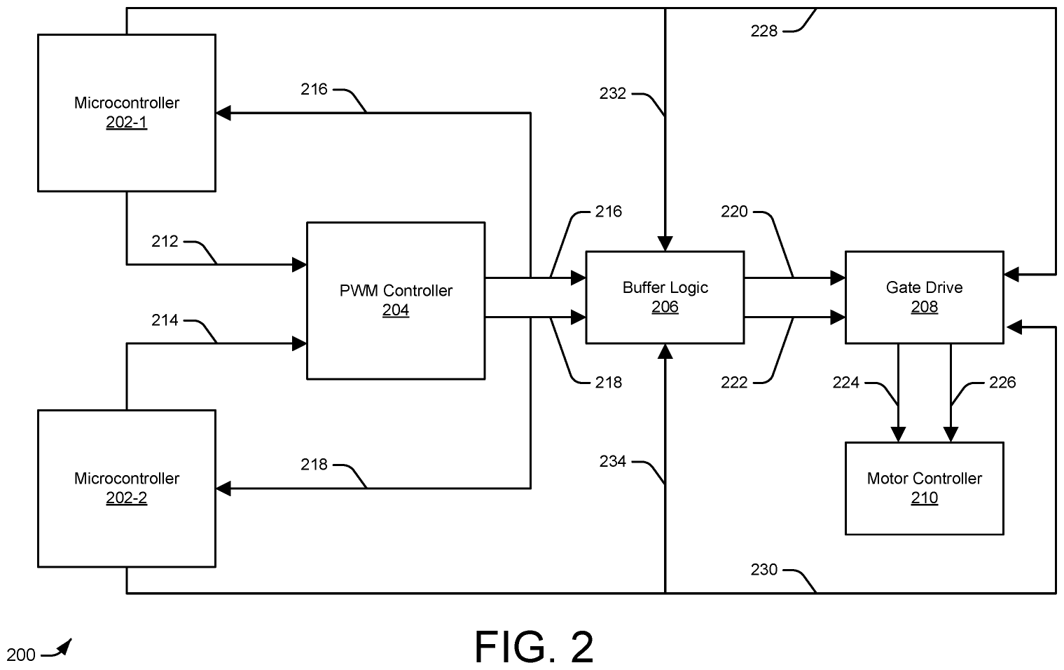

FIG. 2 illustrates an example system 200 for detecting pulse-width modulation (PWM) duty cycle errors, in accordance with embodiments of the present disclosure. In various embodiments, system 200 includes microcontroller 202-1, microcontroller 202-2, PWM controller 204, buffer logic 206, gate drive 208, and motor controller 210. In some embodiments, microcontroller 202-1 generates PWM commands 212 and microcontroller 202-2 generates PWM commands 214 based on one or more inputs, such as inputs based on user interactions with one or more input devices of vehicle 100, inputs received from control system 104, etc. In such embodiments, PWM commands 212, 214 are configured to control at least one controllable component of vehicle 100.

In various embodiments, PWM controller 204 receives PWM commands 212, 214 and generates PWM signals 216 and PWM signals 218 based on the PWM commands 212, 214, respectively. In some embodiments, microcontroller 202-1 receives PWM signals 216 (and microcontroller 202-2 receives PWM signals 218) generated by PWM controller 204 as feedback. In such embodiments, microcontroller 202-1 is configured to compare a duty cycle of the PWM signals 216 with a duty cycle of the PWM commands 212 that were processed by the PWM controller 204 to generate the PWM signals 216.

In one or more embodiments, microcontroller 202-1 can detect a duty cycle error if the duty cycle of PWM signals 216 differs from the duty cycle of PWM commands 212 by more than a threshold amount (e.g., one percent, two percent, three percent, etc.). In some examples in which microcontroller 202-1 detects the duty cycle error, microcontroller 202-1 may trigger a safe state 228 in response to detecting the error. Similarly, microcontroller 202-2 can detect a duty cycle error if the duty cycle of PWM signals 218 differs from the duty cycle of PWM commands 214 by more than the threshold amount. Like microcontroller 202-1, microcontroller 202-2 can trigger a safe state 230 in response to detecting the duty cycle error. In various embodiments, safe states 228, 230 are configured to prevent occurrence of further duty cycle errors. Additional techniques for detecting duty cycle errors associated with PWM signals 216, 218 and triggering safe states 228, 230 are described below.

In various embodiments, buffer logic 206 receives PWM signals 216 and PWM signals 218, buffers and/or isolates the PWM signals 216, 218, and outputs PWM control signals 220 and PWM control signals 222, respectively. In some embodiments, gate drive 208 receives PWM control signals 220, 222. In such embodiments, gate drive 208 may be configured to generate drive signals 224, 226 based on PWM control signals 220, 222, respectively. Gate drive 208 may receive PWM control signals 220, 222 as low-power and low-impedance PWM signals. In one or more embodiments, gate drive 208 may generate drive signals 224, 226 as high-power signals (e.g., capable of driving gates of power transistors of motor controller 210).

In various embodiments, motor controller 210 receives drive signals 224, 226, which are then output by the motor controller 210 to cause the switches of power transistors to open and close rapidly (e.g., at a high frequency) based on the duty cycles of PWM signals 216, 218. Opening and closing the power transistor switches controls a flow of current through windings of a motor (not shown), which generates torque and rotates at least one motor component controlled by motor controller 210.

### Detecting PWM Duty Cycle Errors

In various embodiments, PWM commands 212, 214 may include a single PWM command or multiple PWM commands such as two or more PWM commands. In the example illustrated in FIG. 2, PWM controller 204 receives PWM commands 212, 214; however, in other examples, system 200 does not include PWM controller 204. Similarly, in the example depicted in FIG. 2, microcontroller 202-2 generates PWM commands 214; however, in other examples, system 200 includes only one microcontroller 202 (e.g., microcontroller 202-1).

In some embodiments, PWM controller 204 includes a field programmable gate array (FPGA) that generates PWM signals 216, 218. In one or more embodiments, PWM controller 204 (e.g., an FPGA) generates PWM signals 216 (e.g., upper phase PWM signals) and PWM signals 218 (e.g., lower phase PWM signals) for switching power modules (not shown) at particular switching frequencies. In other embodiments, PWM controller 204 includes an application-specific integrated circuit (ASIC) that generates PWM signals 216, 218. It is to be appreciated that PWM controller 204 can be implemented using hardware, software (e.g., firmware), or combinations of hardware and software.

In some embodiments, microcontrollers 202-1, 202-2 each include a generic timer module (not shown) which microcontroller 202-1 utilizes to compare the duty cycles of PWM signals 216 with the duty cycles of PWM commands 212, and microcontroller 202-2 utilizes to compare the duty cycles of PWM signals 218 with the duty cycles of PWM commands 214. For instance, the generic timer module included in microcontroller 202-1 and the generic timer module included in microcontroller 202-2 are each capable of compensating for delays and dead time between generation of PWM commands 212, 214 and generation of PWM signals 216, 218 PWM in order to ensure accurate comparisons between PWM signals and the PWM commands that were processed to generate the PWM signals. In various embodiments, detecting duty cycle errors includes applying a delay that begins after PWM commands 212, 214 are generated (e.g., and ends upon generation of PWM signals 216, 218). In one or more embodiments, detecting duty cycle errors includes applying a feedback delay that begins after PWM signals 216, 218 are generated (e.g., and ends when microcontrollers 202-1, 202-2 receive PWM signals 216, 218 as feedback).

In general, microcontrollers 202-1, 202-2 can implement any technique to compare PWM signals with corresponding PWM commands to identify errors. In some examples, microcontrollers 202-1, 202-2 may compare samples of each of the PWM signals (e.g., PWM signals 216, 218) with corresponding PWM commands (e.g., PWM commands 212, 214) in order to detect duty cycle errors.

In various embodiments, triggering a safe state 228, 230 at gate drive 208 may cause an open switch state of motor controller 210, a closed switch state of motor controller 210, bypass PWM controller 204, etc. In one or more examples, triggering a safe state 228, 230 ensures that PWM signals 216, 218 are not propagated to motor controller 210. Notably, microcontrollers 202-1, 202-2 are capable of detecting a duty cycle error and triggering respective safe states 228, 230 in microseconds (e.g., less than 0.5 milliseconds, less than 0.25 milliseconds, less than 0.1 milliseconds, etc.) in order to prevent unintended operation of the vehicles and/or damage to vehicle components.

In some embodiments, microcontroller 202-1 can be directly connected to buffer logic 206 via connection/interconnect 232 and microcontroller 202-2 may be directly connected to buffer logic 206 via connection/interconnect 234. In these embodiments, microcontrollers 202-1, 202-2 may be capable of controlling gate drive 208 though buffer logic 206 via connections/interconnects 232, 234, respectively. For example, microcontrollers 202-1, 202-2 may control gate drive 208 through buffer logic 206 in addition or alternative to triggering safe respective safe states 228, 230.

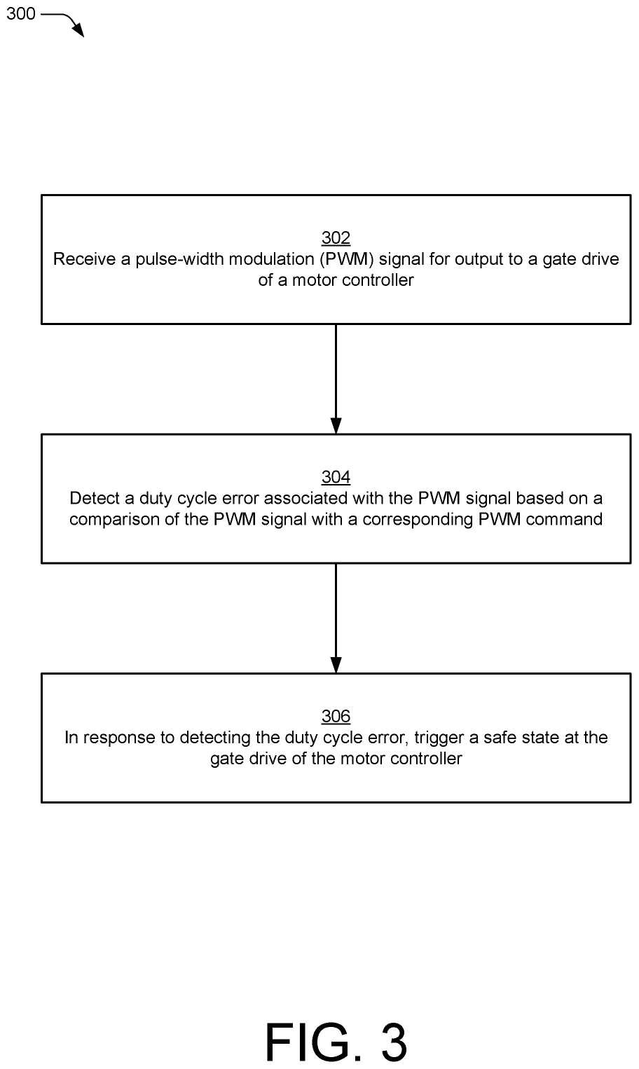

FIG. 3 is a flowchart illustrating a method 300 of triggering a safe state at a gate drive of a motor controller in response to detecting a duty cycle error associated with a pulse-width modulation (PWM) signal, in accordance with embodiments of the present disclosure. In some embodiments, the PIM ECU performs method 300. Additionally or alternatively, other ECUs included in control system 104 may perform one or more steps of method 300. Method 300 is described with reference to system 200; however, it should be appreciated that method 300 can be performed by any system.

At step 302, a PWM signal for output to a gate drive of a motor controller may be received. In some embodiments, microcontroller 202-1 can receive PWM signals 216 via feedback from PWM controller 204.

At step 304, a duty cycle error associated with the PWM signal can be detected based on a comparison of the PWM signal with a corresponding PWM command. In one or more embodiments, microcontroller 202-1 may detect a duty cycle error by comparing a duty cycle of PWM signals 216 with a duty cycle of PWM commands 212. For example, microcontroller 202-1 can detect the duty cycle error if the duty cycle of PWM signals 216 differs from the duty cycle of PWM commands 212 by more than a threshold amount.

At step 306, in response to detecting the duty cycle error, a safe state may be triggered at the gate drive of the motor controller. In some examples, microcontroller 202-1 may trigger safe state 228 at gate drive 208 in response to detecting the duty cycle error. Safe state 228 can be an open switch state or a closed switch state of motor controller 210. In various embodiments, triggering safe state 228 may cause PWM controller 204 to be bypassed.

FIG. 4 is a flowchart illustrating a method 400 of detecting duty cycle errors, in accordance with embodiments of the present disclosure. In some embodiments, control system 104 may implement method 400. In other embodiments, method 400 can be implemented by any system.

At step 402, control system 104 may receive a current rotational speed of a motor component controlled by motor controller 210.

At step 404, control system 104 may determine whether the current rotational speed of the motor component is greater than a rotational speed threshold. In some examples, the rotational speed threshold can be 2000 revolutions per minute (RPM). In other examples, the rotational speed threshold may be less than 2000 RPM or greater than 2000 RPM. If the current rotational speed of the motor component is not greater than the rotational speed threshold (no), method 400 may continue with step 406.

At step 406, control system 104 compares PWM signals 216 with PWM commands 212. In some examples, microcontroller 202-1 compares the duty cycle of PWM signals 216 with the duty cycle of PWM commands 212. Next, at step 408, control system 104 determines whether a difference between the duty cycle of PWM signals 216 and the duty cycle of PWM commands 212 is greater than a threshold difference. For example, microcontroller 202-1 determines whether the difference between the duty cycle of PWM signals 216 and the duty cycle of PWM commands 212 is greater than the threshold difference.

If the difference between the duty cycle of PWM signals 216 and the duty cycle of PWM commands 212 is not greater than the threshold difference (no), method 400 may continue with step 410. At step 410, control system 104 determines that no duty cycle error is detected. If the difference between the duty cycle of PWM signals 216 and the duty cycle of PWM commands 212 is greater than the threshold difference (yes), method 400 continues with step 412. At step 412, control system 104 determines that a duty cycle error is detected. Then, at step 414, control system 104 triggers a safe state. In some examples, microcontroller 202-1 triggers safe state 228.

At step 404, if the current rotational speed of the motor component is greater than the rotational speed threshold (yes), method 400 may continue with step 416. At step 416, control system 104 may compare results of current-based torque calculations for the motor component controlled by motor controller 210 and results of voltage-based torque calculations for the motor component. At step 418, control system 104 may determine whether the results of current-based torque calculations for the motor component and the results of voltage-based torque calculations for the motor component differ by more than a threshold amount, indicating a torque monitor failure. If a torque monitor failure is not indicated (no), method 400 may continue with step 420. At step 420, control system 104 may determine that no duty cycle error is detected. If a torque monitor failure is indicated (yes), then method may continue with step 418.

At step 422, control system 104 may compare a calculated phase current for safe action of the torque monitor failure for the motor component controlled by motor controller 210 with a measured phase current of the safe action of the torque monitor failure for the motor component. At step 424, control system 104 may determine whether the calculated phase current for the motor component differs from the measured phase current for the motor component by more than a threshold amount, indicating a duty cycle error caused the torque monitor failure. If a duty cycle error is not indicated as causing the torque monitor failure (no), then method 400 may continue with step 426. At step 426 control system 104 may determine that no duty cycle error is detected. If a duty cycle error is indicated as causing the torque monitor failure (yes), then method 400 may continue with step 428. At step 428, control system 104 may determine that a duty cycle error is detected. Then, at step 414, control system 104 may trigger a safe state. In one or more examples, microcontroller 202-1 triggers safe state 228.

FIG. 5A is a schematic of an example computing system 500, in accordance with embodiments of the present disclosure. Computer system 500 may include a processor 502, memory 504, storage 506, an input/output (I/O) interface 508, a communication interface 510, and a bus 512. Although this disclosure describes one example computer system including specified components in a particular arrangement, this disclosure contemplates any suitable computer system with any suitable number of any suitable components in any suitable arrangement. As an example and not by way of limitation, computer system 500 may be an electronic control unit (ECU), an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 500 may include one or more computer systems 500; be unitary or distributed, span multiple locations, machines, or data centers; or reside in a cloud, which may include one or more cloud components in one or more networks. Where appropriate, computer system(s) 500 may perform, at different times or at different locations, in real time or in batch mode, one or more steps of one or more methods described or illustrated herein.

Processor 502 (e.g., compute units) may include hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506 (e.g., storage units). Processor 502 may include one or more internal caches for data, instructions, or addresses.

In particular embodiments, memory 504 includes main memory for storing instructions for processor 502 to execute or data for processor 502 to operate on. In particular embodiments, one or more memory management units (MMUs) reside between processor 502 and memory 504 and facilitate accesses to memory 504 requested by processor 502. In particular embodiments, memory 504 includes random access memory (RAM). This disclosure contemplates any suitable RAM.

In particular embodiments, storage 506 includes mass storage for data or instructions. As an example and not by way of limitation, storage 506 may include a removable disk drive, flash memory, an optical disc, a magneto-optical disc, magnetic tape, or a Universal Serial Bus (USB) drive or two or more of these. Storage 506 may include removable or fixed media and may be internal or external to computer system 500. Storage 506 may include any suitable form of non-volatile, solid-state memory or read-only memory (ROM).

In particular embodiments, I/O interface 508 includes hardware, software, or both, providing one or more interfaces for communication between computer system 500 and one or more input and/or output (I/O) devices. Computer system 500 may be communicably connected to one or more of these I/O devices, which may be incorporated into, plugged into, paired with, or otherwise communicably connected to vehicle 100 (e.g., through the PIM ECU). An input device may include any suitable device for converting volitional user inputs into digital signals that can be processed by computer system 500, such as, by way of example and not limitation, a steering wheel, a touch screen, a microphone, a joystick, a scroll wheel, a button, a toggle, a switch, a dial, or a pedal. An input device may include one or more sensors for capturing different types of information. An output device may include devices designed to receive digital signals from computer system 500 and convert them to an output format, such as, by way of example and not limitation, speakers, headphones, a display screen, a heads-up display, a lamp, a smart vehicle accessory, another suitable output device, or a combination thereof. This disclosure contemplates any suitable I/O devices and any suitable I/O interfaces 508 for them. I/O interface 508 may include one or more I/O interfaces 508, where appropriate.

In particular embodiments, communication interface 510 includes hardware, software, or both providing one or more interfaces for data communication between computer system 500 and one or more other computer systems 500 or one or more networks. Communication interface 510 may include one or more interfaces to a controller area network (CAN) or to a local interconnect network (LIN). Communication interface 510 may include one or more of a serial peripheral interface (SPI) or an isolated serial peripheral interface (isoSPI). In some embodiments, communication interface 510 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 512 includes hardware, software, or both coupling components of computer system 500 to each other. Bus 512 may include any suitable bus, as well as one or more buses 512, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 5B illustrates example firmware 514 for a vehicle electronic control unit (ECU) as described with respect to control system 104, in accordance with embodiments of the present disclosure. Firmware 514 may include functions 516 for analyzing sensor data based on signals received from sensors or cameras received through communication interface 510. Firmware 514 may include functions 518 for processing user input (e.g., directly provided by a driver of or passenger in vehicle 100 or provided through a computing device) received through I/O interface 508. Firmware 514 may include functions 520 for logging detected events (which may be stored in storage 506 or uploaded to the cloud), as well as functions for reporting detected events (e.g., to a driver or passenger of vehicle 100 through an instrument display or interactive interface of vehicle 100, or to a vehicle manufacturer, service provider, or third party through communication interface 510). Firmware 514 may include functions 522 for assessing safety parameters (e.g., monitoring the temperature of a vehicle battery or the distance between vehicle 100 and nearby vehicles). Firmware 514 may include functions 524 for transmitting control signals to components of vehicle 100, including other vehicle ECUs.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially,” “approximately,” “generally,” and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an,” and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A system comprising:
a memory; and
at least one processor coupled to the memory and configured to:
receive a pulse-width modulation (PWM) signal for output to a gate drive of a motor controller;
detect a first duty cycle error associated with the PWM signal by comparing the PWM signal with a corresponding PWM command; and
in response to detecting the first duty cycle error, trigger a safe state at the gate drive of the motor controller.

2. The system of claim 1, wherein the safe state comprises at least one of an open switch state or a closed switch state of the motor controller.

3. The system of claim 1, wherein:
the at least one processor is further configured to determine that a current rotational speed of a motor component controlled by the motor controller is less than a rotational speed threshold.

4. The system of claim 3, wherein detecting the first duty cycle error comprises determining that a duty cycle of the PWM signal differs from a duty cycle of the corresponding PWM command by at least one percent.

5. The system of claim 1, wherein the at least one processor is further configured to:
determine that a current rotational speed of a motor component controlled by the motor controller is greater than a rotational speed threshold; and
detect a second duty cycle error by comparing a result of a current-based torque calculation and a result of a voltage-based torque calculation.

6. The system of claim 5, wherein detecting the second duty cycle error further comprises comparing a calculated phase current with a measured phase current.

7. The system of claim 1, wherein the PWM signal is generated by a field programmable gate array.

8. The system of claim 7, wherein the PWM signal is generated based on the corresponding PWM command and at least one additional PWM command generated by at least one additional processor.

9. The system of claim 7, wherein detecting the first duty cycle error comprises applying a delay that begins after the corresponding PWM command is generated.

10. The system of claim 7, wherein triggering the safe state causes the field programmable gate array to be bypassed.

11. A method implemented by one or more computer systems, the method comprising:
receiving a pulse-width modulation (PWM) signal for output to a gate drive of a motor controller;
detecting a duty cycle error associated with the PWM signal by comparing the PWM signal with a corresponding PWM command; and
triggering, in response to detecting the duty cycle error, a safe state at the gate drive of the motor controller.

12. The method of claim 11, further comprising determining that a duty cycle of the PWM signal differs from a duty cycle of the corresponding PWM command by at least one percent.

13. The method of claim 11, wherein the safe state comprises at least one of an open switch state or a closed switch state of the motor controller.

14. The method of claim 11, wherein the PWM signal is generated by a field programmable gate array.

15. The method of claim 14, wherein triggering the safe state causes the field programmable gate array to be bypassed.

16. A system comprising:
a memory; and
one or more processors coupled to the memory and configured to:
receive a pulse-width modulation (PWM) signal for output to a gate drive of a motor controller;
compare a current rotational speed of a motor component controlled by the motor controller with a rotational speed threshold;
based on determining that the current rotational speed is less than the rotational speed threshold, detect a first duty cycle error associated with the PWM signal by comparing the PWM signal with a corresponding PWM command; and
in response to detecting the first duty cycle error, trigger a safe state at the gate drive of the motor controller.

17. The system of claim 16, further comprising detecting a second duty cycle error by comparing a result of a current-based torque calculation and a result of a voltage-based torque calculation.

18. The system of claim 16, further comprising detecting a second duty cycle error by comparing a calculated phase current with a measured phase current.

19. The system of claim 16, wherein the PWM signal is generated by a field programmable gate array.

20. The system of claim 16, wherein the safe state comprises at least one of an open switch state or a closed switch state of the motor controller.
